(19) United States
(12) Patent Application Publication
(10) Pub. No.: US 2017/0250011 A1
(43) Pub. Date: Aug. 31, 2017

(54) THERMOSENSITIVE CHIP FOR COMPOSITE ELECTRODE

(71) Applicant: EXSENSE ELECTRONICS TECHNOLOGY CO., LTD, ZHAOQING CITY (CN)

(72) Inventors: KUN WANG, ZHAOQING CITY (CN); ZHAOXING DUAN, ZHAOQING CITY (CN); JUN YANG, ZHAOQING CITY (CN); QIXING BAI, ZHAOQING CITY (CN); LIMIN TANG, ZHAOQING CITY (CN); JIANKAI YE, ZHAOQING CITY (CN)

(21) Appl. No.: 15/328,689

(22) PCT Filed: Jul. 23, 2015
(86) PCT No.: PCT/CN2015/084975

§ 371 Date: Jan. 24, 2017

(30) Foreign Application Priority Data
Jul. 28, 2014 (CN) 201420420077.X

(51) Int. Cl. H01C 7/04; H01C 17/12; H01C 1/142

(52) U.S. Cl. CPC H01C 7/04; H01C 1/142; H01C 17/12

(57) ABSTRACT

A thermosensitive chip for a composite electrode is provided, including a thermosensitive substrate, wherein each of the two surfaces of the thermosensitive substrate is sequentially provided thereon with a silver electrode and a gold electrode from the inside to the outside in a stacked manner. The thermosensitive chip is suitable for the gold wire bonding technology, the gold electrode on the outer surface thereof facilitates better bonding with a gold wire, and the silver electrode on the bottom of the gold electrode can greatly reduce manufacturing costs. In addition, an operation of coating with gold is conducted through a vacuum sputtering machine, so that the manufacturing process is simple and convenient, and the manufacturing effect is good.

### CROSS-REFERENCE TO RELATED APPLICATIONS

This application claims priority to PCT Application No. PCT/CN2015/084975, having a filing date of Jul. 23, 2015, based off of Chinese Application No. 2014 2042 0077.X having a filing date of Jul. 28, 2014, the entire contents of both which are hereby incorporated by reference.

### FIELD OF TECHNOLOGY

The following relates to the technical field of the thermosensitive chip products, in particular to a thermosensitive chip with a gold electrode which is made by vacuum sputtering.

### BACKGROUND

A Negative Temperature Coefficient (NTC) thermosensitive chip is a thermosensitive semiconductor component with advantages such as high sensitivity, quick response, small size, and so on. With the development of electronic technology, thermosensitive chip products are widely used in all kinds of electrical products in daily life. The thermosensitive chips can be applied not only in the electronic components and sensors, but also to the bonding technology that mostly adopts gold wire bonding. Gold wire bonding is mostly used due to the fact that gold wire and gold electrode can achieve better bonding. However, most of the existing electrodes of the thermosensitive chips are made of silver electrodes, which are coated by silk-screen method. In this method, it's difficult for the silver electrodes to bond with gold wires. There indeed exist gold electrode chips, but their manufacturing costs are relatively high.

Therefore, it is imminent to develop a thermosensitive chip with gold electrode which is suitable for bonding and with relatively low manufacturing costs.

### SUMMARY

The advantage of embodiments of the present invention is to overcome the defects of the known art, and provide a thermosensitive chip for composite electrode which is suitable for the gold wire bonding and easy to manufacture with low cost.

To fulfill the above, the following technical solution is employed:

An aspect relates to a thermosensitive chip for composite electrode of embodiments of the present invention, comprising a thermosensitive substrate, wherein each of two surfaces of the thermosensitive substrate is sequentially provided thereon with a silver electrode and a gold electrode from the inside to the outside in a stacked manner.

Further, the thickness range of the silver electrodes is 3 to 30 micrometer.

Further, the thickness range of the gold electrodes is 0.5 to 5 micrometer.

In embodiments of the present invention, the gold electrodes are formed by evenly coating the silver electrodes with gold using a vacuum sputtering machine.

Compared with the known art, embodiments of the present invention have the following beneficial effects:

(1) The conventional thermosensitive chip with silver electrodes is developed into one with gold electrodes, which is suitable for gold wire bonding.

(2) In embodiments of the present invention, the surface that is directly contacted with the thermosensitive substrate is provided thereon with a silver electrode that is further coated with a gold electrode, thereby avoiding high manufacturing costs caused by mere use of the gold electrodes, and being easy to manufacture.

### BRIEF DESCRIPTION

Some of the embodiments will be described in detail, with reference to the following figures, wherein like designations denote like members, wherein:

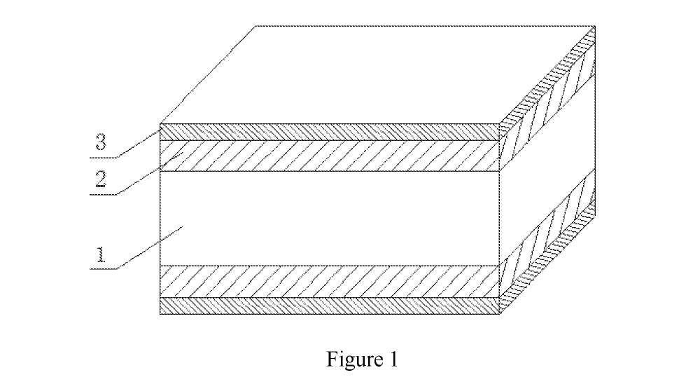

FIG. 1 is a schematic view of the thermosensitive chip for composite electrode of embodiments of the present invention.

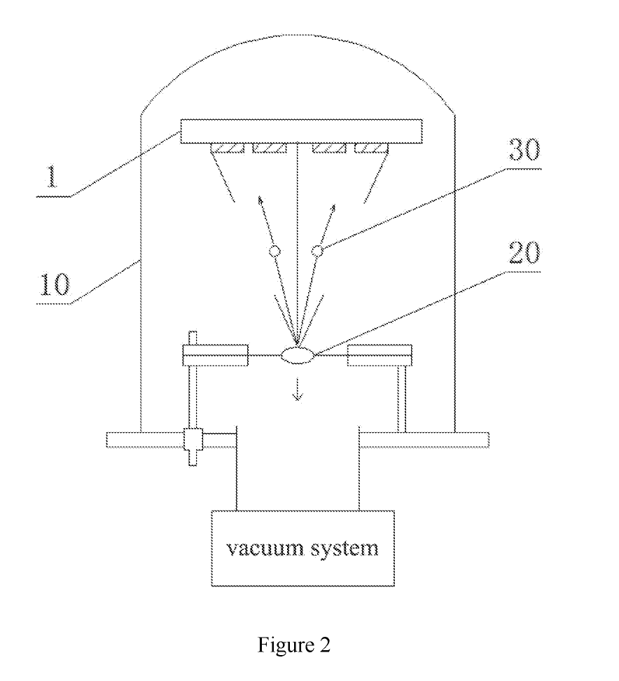

FIG. 2 is a schematic view of the manufacturing process of the thermosensitive chip for composite electrode of embodiments of the present invention using a vacuum sputtering machine.

### DETAILED DESCRIPTION

In FIG. 1, the thermosensitive chip for composite electrode of embodiments of the present invention comprises a thermosensitive substrate 1, wherein each of the two surfaces of the thermosensitive substrate is sequentially provided thereon with a silver electrode 2 and a gold electrode 3 from the inside to the outside in a stacked manner. The thickness range of the silver electrode 2 is 3 to 30 micrometer, and the thickness range of the gold electrode 3 is 0.5 to 5 micrometer.

The gold electrode 3 in embodiments of the present invention is formed by evenly coating the silver electrode with gold using a vacuum sputtering machine.

The manufacturing process of the thermosensitive chip for a composite electrode of embodiments of the present invention using a vacuum sputtering machine 10 will be described in detail below.

(1) to complete the preparatory work of making the thermosensitive substrate 1: first mixing ingredients, ball-milling, ultra-high pressure molding, sintering, slicing, coating silver, sintering silver, and then acquiring the thermosensitive substrate 1 with silver electrodes.

(2) a crucible 20 is disposed inside the vacuum sputtering machine 10. Place the gold inside crucible 20 as evaporative material.

(3) to place the thermosensitive substrate 1 with silver electrodes in front of the crucible 20 inside the vacuum sputtering machine 10.

(4) to turn on the vacuum sputtering machine 10 to evacuate to a high vacuum, then the crucible 20 is heated to evaporate the gold therein so that the gold molecules are sputtered onto the surfaces of the silver electrodes 2 of the thermosensitive substrate 1.

(5) To take out the thermosensitive substrate 1 whose surfaces are coated evenly with gold after completing the system operation.

(6) to slice the thermosensitive substrate 1 coated with gold, and then acquire the thermosensitive chip for composite electrode of embodiments of the present invention.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1-4. (canceled)

5. A thermosensitive chip for composite electrode, comprising a thermosensitive substrate, wherein each of two surfaces of the thermosensitive substrate is sequentially provided thereon with a silver electrode and a gold electrode from inside to outside in a stacked manner.

6. The thermosensitive chip for composite electrode of claim 5, wherein thickness range of the silver electrodes is 3 to 30 micrometers.

7. The thermosensitive chip for composite electrode of claim 5, wherein thickness range of the gold electrodes is 0.5 to 5 micrometers.

8. The thermosensitive chip for composite electrode of claim 6, wherein thickness range of the gold electrodes is 0.5 to 5 micrometer.

9. The thermosensitive chip for composite electrode of claim 7, wherein the gold electrodes are formed by evenly coating the silver electrodes with gold using a vacuum sputtering machine.

10. The thermosensitive chip for composite electrode of claim 8, wherein the gold electrodes are formed by evenly coating the silver electrodes with gold using a vacuum sputtering machine.
